(19) United States
(12) Patent Application Publication
(10) Pub. No.: US 2016/0119120 A1
(43) Pub. Date: Apr. 28, 2016

(54) METHOD AND APPARATUS FOR PUBLIC-KEY ENCRYPTED COMMUNICATION

(71) Applicant: HUAWEI TECHNOLOGIES CO.,LTD., Shenzhen (CN)

(72) Inventors: Baocang Wang, Xi'an (CN); Hao Lei, Beijing (CN); Yupu Hu, Xi'an (CN)

(73) Assignee: HUAWEI TECHNOLOGIES CO.,LTD., Shenzhen (CN)

(21) Appl. No.: 14/985,942

(22) Filed: Dec. 31, 2015

Related U.S. Application Data
(63) Continuation of application No. PCT/CN2015/071619, filed on Jan. 27, 2015.

(30) Foreign Application Priority Data
Jul. 3, 2014 (CN) 201410315215.2

(51) Int. Cl. H04L 9/06; H04L 9/30; H04L 9/14

(52) U.S. Cl. CPC H04L 9/0618; H04L 9/14; H04L 9/3093; H04L 2209/24

(57) ABSTRACT

A method and an apparatus for public-key encrypted communication includes: encrypting, by a first device, random information according to a first public key to obtain a first ciphertext; encrypting, by the first device, plaintext information according to a second public key to obtain a second ciphertext, where the plaintext information is unencrypted data to be sent by the first device to a second device, the first public key is represented in a form of a polynomial, the first public key is obtained through calculation on a truncated polynomial ring according to system parameters, the second public key is represented in a form of a polynomial, the second public key is randomly selected on a truncated polynomial ring, and the random information is randomly selected on a truncated polynomial ring; and sending, by the first device, the first ciphertext and the second ciphertext to the second device.

### CROSS-REFERENCE TO RELATED APPLICATIONS

This application is a continuation of International Application No. PCT/CN2015/071619, filed on Jan. 27, 2015, which claims priority to Chinese Patent Application No. 201410315215.2, filed on Jul. 3, 2014, both of which are hereby incorporated by reference in their entireties.

### TECHNICAL FIELD

Embodiments of the present invention relate to communications technologies, and in particular, to a method and an apparatus for public-key encrypted communication.

### BACKGROUND

In communications technologies, to ensure secrecy of communication between two communication individuals, data needs to be encrypted using a key at a transmit end and decrypted using a key at a receive end. If the key used for encryption and the key used for decryption are the same, the encryption is referred to as symmetric key encryption; if the two keys are different, the encryption is referred to as asymmetric key encryption, which is also referred to as public key encryption. The public key encryption manner has two important principles: First, it is required that an encrypted ciphertext must be secure on the premise that an encryption algorithm and a public key are both made public; second, it is required that calculation or processing for both data encryption at the transmit end and data decryption at the receive end by using a private key should be simple but deciphering should be difficult for other persons not having the private key. With development of computer networks, requirements on information confidentiality become increasingly high, and a public key cryptographic algorithm has demonstrated irreplaceable advantages over a symmetric key encryption algorithm.

An existing secure communication method based on a public key system uses a public key system number theory research unit (NTRU). The NTRU is a cryptographic system based on a polynomial ring. A specific algorithm is as follows: using a public key and a private key respectively for encryption and decryption, where the public key and the private key are calculated according to system parameters N, p, and q and two randomly selected polynomials f and g. Such a method has a low security problem.

### SUMMARY

Embodiments of the present invention provide a method and an apparatus for public-key encrypted communication, so as to achieve a public-key encrypted communication manner with higher security.

A first aspect of the embodiments of the present invention provides a method for public-key encrypted communication, including:

encrypting, by a first device, random information according to a first public key to obtain a first ciphertext; encrypting, by the first device, plaintext information according to a second public key to obtain a second ciphertext, where the plaintext information is unencrypted data to be sent by the first device to a second device, the first public key is represented in a form of a polynomial, the first public key is obtained through calculation on a truncated polynomial ring according to system parameters, the second public key is represented in a form of a polynomial, the second public key is randomly selected on a truncated polynomial ring, and the random information is randomly selected on a truncated polynomial ring; and

sending, by the first device, the first ciphertext and the second ciphertext to the second device.

With reference to the first aspect, in a first possible implementation manner of the first aspect, the random information includes a first random polynomial and a second random polynomial, and the encrypting, by a first device, random information according to a first public key to obtain a first ciphertext specifically includes:

calculating, by the first device, on a first truncated polynomial ring modulo a first system parameter according to the first public key, the first random polynomial, and the second random polynomial, to obtain the first ciphertext.

With reference to the first possible implementation manner of the first aspect, in a second possible implementation manner of the first aspect, the plaintext information is represented as a polynomial on a second truncated polynomial ring modulo a second system parameter, and the encrypting, by the first device, plaintext information according to a second public key to obtain a second ciphertext specifically includes:

calculating, by the first device, on the second truncated polynomial ring modulo the second system parameter according to the second public key, the first random polynomial, the second random polynomial, and the plaintext information, to obtain the second ciphertext.

With reference to the first possible implementation manner of the first aspect, in a third possible implementation manner of the first aspect, the calculating, by the first device, on a first truncated polynomial ring modulo a first system parameter according to the first public key, the first random polynomial, and the second random polynomial, to obtain the first ciphertext specifically includes:

calculating on the first truncated polynomial ring according to c₁=r₁h₁+r₂ to obtain the first ciphertext, where h₁ is the first public key, r₁ is the first random polynomial, r₂ is the second random polynomial, the first truncated polynomial ring is Z_{q}_{₁}[X]/X^{N}−1, and q₁ is the first system parameter.

With reference to the second possible implementation manner of the first aspect, in a fourth possible implementation manner of the first aspect, the calculating, by the first device, on the second truncated polynomial ring modulo the second system parameter according to the second public key, the first random polynomial, the second random polynomial, and the plaintext information, to obtain the second ciphertext specifically includes:

calculating on the second truncated polynomial ring according to c₂=r₁h₂+r₂+M to obtain the second ciphertext, where h₂ is the second public key, r₁ is the first random polynomial, r₂ is the second random polynomial, the second truncated polynomial ring is Z_{q}_{₁}[X]/X^{N}−1, and q₂ is the second system parameter.

With reference to any one of the second to third possible implementation manners of the first aspect, in a fifth possible implementation manner of the first aspect, the first public key is obtained through calculation on the first truncated polynomial ring modulo the first system parameter according to the first system parameter, a third random polynomial, and a fourth random polynomial, the third random polynomial has an inverse element on both the first truncated polynomial ring modulo the first system parameter and a third truncated polynomial ring modulo a third system parameter, and the fourth random polynomial has an inverse element on the first truncated polynomial ring modulo the first system parameter.

With reference to the fifth possible implementation manner of the first aspect, in a sixth possible implementation manner of the first aspect, the first public key is obtained through calculation on the first truncated polynomial ring according to h₁=pf_{q}_{₁}⁻¹g, where p is the third system parameter, f is the third random polynomial, f_{q}_{₁}⁻¹ is an inverse element of the third random polynomial on the first truncated polynomial ring modulo the first system parameter, g is the fourth random polynomial, q₁ is the first system parameter, and the first truncated polynomial ring is Z_{q}_{₁}[X]/X^{N}−1.

With reference to the second possible implementation manner of the first aspect, in a seventh possible implementation manner of the first aspect, the second public key is randomly selected on the second truncated polynomial ring, and the second truncated polynomial ring is Z_{q}_{₂}[X]/X^{N}−1.

A second aspect of the embodiments of the present invention provides a method for public-key encrypted communication, including:

receiving, by a second device, a first ciphertext and a second ciphertext that are sent by a first device;

calculating, by the second device, according to a first private key, a second private key, and the first ciphertext to obtain a second random polynomial, and obtaining a first random polynomial according to a third private key, where the first private key is represented in a form of a polynomial, the first private key is randomly selected on a truncated polynomial ring, the second private key is represented in a form of a polynomial, the second private key is an inverse element of the first private key on the truncated polynomial ring, the third private key is represented in a form of a polynomial, and the third private key is obtained through calculation according to an inverse element of a system parameter and a polynomial having an inverse element on a truncated polynomial; and

obtaining, by the second device, plaintext information according to the first random polynomial, the second random polynomial, the second ciphertext, and a second public key, where the plaintext information is unencrypted data to be sent by the first device to the second device, the second public key is represented in a form of a polynomial, and the second public key is randomly selected on a truncated polynomial ring.

With reference to the second aspect, in a first possible implementation manner of the second aspect, the calculating, by the second device, according to a first private key, a second private key, and the first ciphertext to obtain a second random polynomial specifically includes:

calculating, by the second device, on a first truncated polynomial ring modulo a first system parameter according to the first ciphertext and the first private key to obtain a procedure parameter; and

obtaining, by the second device, the second random polynomial on a third truncated polynomial ring modulo a third system parameter according to the procedure parameter and the second private key.

With reference to the first possible implementation manner of the second aspect, in a second possible implementation manner of the second aspect, the obtaining a first random polynomial according to a third private key specifically includes:

calculating, by the second device, on the first truncated polynomial ring modulo the first system parameter according to the procedure parameter and the third private key to obtain the first random polynomial.

With reference to the second possible implementation manner of the second aspect, in a third possible implementation manner of the second aspect, the obtaining, by the second device, plaintext information according to the first random polynomial, the second random polynomial, the second ciphertext, and a second public key specifically includes:

calculating, by the second device, on a second truncated polynomial ring modulo a second system parameter according to the first random polynomial, the second random polynomial, the second ciphertext, and the second public key to obtain the plaintext information.

With reference to the first possible implementation manner of the second aspect, in a fourth possible implementation manner of the second aspect, the calculating, by the second device, on a first truncated polynomial ring modulo a first system parameter according to the first ciphertext and the first private key to obtain a procedure parameter specifically includes:

calculating, by the second device, on the first truncated polynomial ring modulo the first system parameter according to s=fc₁ to obtain the procedure parameter, where f is the first private key, and c₁ is the first ciphertext.

With reference to the fourth possible implementation manner of the second aspect, in a fifth possible implementation manner of the second aspect, the obtaining, by the second device, the second random polynomial on a third truncated polynomial ring modulo a third system parameter according to the procedure parameter and the second private key specifically includes:

calculating, by the second device, on the third truncated polynomial ring modulo the third system parameter according to sₚ=s(mod p) and r₂=sₚfₚ⁻¹ to obtain the second random polynomial, where p is the third system parameter, fₚ⁻¹ is the second private key, s is the procedure parameter, and the third truncated polynomial ring is Zₚ[X]/X^{N}−1.

With reference to the fourth possible implementation manner of the second aspect, in a sixth possible implementation manner of the second aspect, the calculating, by the second device, on the first truncated polynomial ring modulo the first system parameter according to the procedure parameter and the third private key to obtain the first random polynomial specifically includes:

calculating on the first truncated polynomial ring according to sₚ=s(mod p) and r₁=(s−sₚ)G to obtain the first random polynomial, where s is the procedure parameter, q₁ is the first system parameter, p is the third system parameter, G is the third private key, and the first truncated polynomial ring is Z_{q}_{₁}[X]/X^{N}−1.

With reference to the third possible implementation manner of the second aspect, in a seventh possible implementation manner of the second aspect, the calculating, by the second device, on a second truncated polynomial ring modulo a second system parameter according to the first random polynomial, the second random polynomial, the second ciphertext, and the second public key to obtain the plaintext information specifically includes:

calculating on the second truncated polynomial ring according to M=c₂−r₁h₂−r₂ to obtain the plaintext information, where c₂ is the second ciphertext, r₁ is the first random polynomial, r₂ is the second random polynomial, and h₂ is the second public key.

With reference to the second possible implementation manner of the second aspect, in an eighth possible implementation manner of the second aspect, the first private key is a third random polynomial, the second private key is an inverse element of the third random polynomial on the third truncated polynomial ring modulo the third system parameter, and the third private key is obtained through calculation according to an inverse element of the third system parameter and an inverse element of a fourth random polynomial on the first truncated polynomial ring modulo the first system parameter.

With reference to the eighth possible implementation manner of the second aspect, in a ninth possible implementation manner of the second aspect, the third private key is obtained through calculation on the first truncated polynomial modulo the first system parameter according to G=p⁻¹g_{q}_{₁}⁻¹, where p⁻¹ is an inverse element of the third system parameter modulo the first system parameter, q₁ is the first system parameter, g_{q}_{₁}⁻¹ is an inverse element of the fourth random polynomial on the first truncated polynomial ring, and g is the fourth random polynomial.

A third aspect of the embodiments of the present invention provides an apparatus for public-key encrypted communication, including:

an encryption unit, configured to perform encryption according to a first public key and random information to obtain a first ciphertext; and further configured to encrypt plaintext information according to a second public key to obtain a second ciphertext, where the plaintext information is unencrypted data to be sent by the first device to a second device, the first public key is represented in a form of a polynomial, the first public key is obtained through calculation on a truncated polynomial ring according to system parameters, the second public key is represented in a form of a polynomial, the second public key is randomly selected on a truncated polynomial ring, and the random information is randomly selected on a truncated polynomial ring; and

a transceiver unit, configured to send the first ciphertext and the second ciphertext to the second device.

With reference to the third aspect, in a first possible implementation manner of the third aspect, the random information includes a first random polynomial and a second random polynomial, and the encryption unit is specifically configured to:

calculate on a first truncated polynomial ring modulo a first system parameter according to the first public key, the first random polynomial, and the second random polynomial to obtain the first ciphertext.

With reference to the first possible implementation manner of the third aspect, in a second possible implementation manner of the third aspect, the plaintext information is represented as a polynomial on a second truncated polynomial ring modulo a second system parameter, and the encryption unit is further specifically configured to:

calculate on the second truncated polynomial ring modulo the second system parameter according to the second public key, the first random polynomial, the second random polynomial, and the plaintext information to obtain the second ciphertext.

With reference to the first possible implementation manner of the third aspect, in a third possible implementation manner of the third aspect, the encryption unit is configured to calculate on the first truncated polynomial ring modulo the first system parameter according to the first public key, the first random polynomial, and the second random polynomial to obtain the first ciphertext, and is specifically configured to:

calculate on the first truncated polynomial ring according to c₁=r₁h₁+r₂ to obtain the first ciphertext, where h₁ is the first public key, r₁ is the first random polynomial, r₂ is the second random polynomial, the first truncated polynomial ring is Z_{q}_{₁}[X]/X^{N}−1, and q₁ is the first system parameter.

With reference to the second possible implementation manner of the third aspect, in a fourth possible implementation manner of the third aspect, the encryption unit is configured to calculate on the second truncated polynomial ring modulo the second system parameter according to the second public key, the first random polynomial, the second random polynomial, and the plaintext information to obtain the second ciphertext, and is specifically configured to:

calculate on the second truncated polynomial ring according to c₂=r₁h₂+r₂+M to obtain the second ciphertext, where h₂ is the second public key, r₁ is the first random polynomial, r₂ is the second random polynomial, the second truncated polynomial ring is Z_{q}_{₂}[X]/X^{N}−1, and q₂ is the second system parameter.

With reference to any one of the second to third possible implementation manners of the third aspect, in a fifth possible implementation manner of the third aspect, the first public key is obtained through calculation on the first truncated polynomial ring modulo the first system parameter according to the first system parameter, a third random polynomial, and a fourth random polynomial, the third random polynomial has an inverse element on both the first truncated polynomial ring modulo the first system parameter and a third truncated polynomial ring modulo a third system parameter, and the fourth random polynomial has an inverse element on the first truncated polynomial ring modulo the first system parameter.

With reference to the fifth possible implementation manner of the third aspect, in a sixth possible implementation manner of the third aspect, the first public key is obtained through calculation on the first truncated polynomial ring according to h₁=pf_{q}_{₁}⁻¹g, where p is the third system parameter, f is the third random polynomial, f_{q}_{₁}⁻¹ is an inverse element of the third random polynomial on the first truncated polynomial ring modulo the first system parameter, g is the fourth random polynomial, q₁ is the first system parameter, and the first truncated polynomial ring is Z_{q}_{₁}[X]/X^{N}−1.

With reference to the second possible implementation manner of the third aspect, in a seventh possible implementation manner of the third aspect, the second public key is randomly selected on the second truncated polynomial ring, and the second truncated polynomial ring is Z_{q}_{₂}[X]/X^{N}−1.

A fourth aspect of the embodiments of the present invention provides an apparatus for public-key encrypted communication, including:

a transceiver unit, configured to receive a first ciphertext and a second ciphertext that are sent by a first device; and

a decryption unit, configured to calculate according to a first private key, a second private key, and the first ciphertext to obtain a second random polynomial, and obtain a first random polynomial according to a third private key, where the first private key is represented in a form of a polynomial, the first private key is randomly selected on a truncated polynomial ring, the second private key is represented in a form of a polynomial, the second private key is an inverse element of the first private key on the truncated polynomial ring, the third private key is represented in a form of a polynomial, and the third private key is obtained through calculation according to an inverse element of a system parameter and a polynomial having an inverse element on a truncated polynomial, where

the decryption unit is further configured to obtain plaintext information according to the first random polynomial, the second random polynomial, the second ciphertext, and a second public key, where the plaintext information is unencrypted data to be sent by the first device to the second device, the second public key is represented in a form of a polynomial, and the second public key is randomly selected on a truncated polynomial ring.

With reference to the fourth aspect, in a first possible implementation manner of the fourth aspect, the decryption unit is specifically configured to:

calculate on a first truncated polynomial ring modulo a first system parameter according to the first ciphertext and the first private key to obtain a procedure parameter; and

obtain the second random polynomial on a third truncated polynomial ring modulo a third system parameter according to the procedure parameter and the second private key.

With reference to the first possible implementation manner of the fourth aspect, in a second possible implementation manner of the fourth aspect, the decryption unit is further specifically configured to:

calculate, by the second device, on the first truncated polynomial ring modulo the first system parameter according to the procedure parameter and the third private key to obtain the first random polynomial.

With reference to the second possible implementation manner of the fourth aspect, in a third possible implementation manner of the fourth aspect, the decryption unit is further specifically configured to:

calculate on a second truncated polynomial ring modulo a second system parameter according to the first random polynomial, the second random polynomial, the second ciphertext, and the second public key to obtain the plaintext information.

With reference to the first possible implementation manner of the fourth aspect, in a fourth possible implementation manner of the fourth aspect, the decryption unit calculates on the first truncated polynomial ring modulo the first system parameter according to the first ciphertext and the first private key to obtain the procedure parameter, and is specifically configured to:

calculate on the first truncated polynomial ring modulo the first system parameter according to s=fc₁ to obtain the procedure parameter, where f is the first private key, and c₁ is the first ciphertext.

With reference to the fourth possible implementation manner of the fourth aspect, in a fifth possible implementation manner of the fourth aspect, the decryption unit obtains the second random polynomial on the third truncated polynomial ring modulo the third system parameter according to the procedure parameter and the second private key, and is specifically configured to:

calculate on the third truncated polynomial ring modulo the third system parameter according to sₚ=s(mod p) and r₂=sₚfₚ⁻¹ to obtain the second random polynomial, where p is the third system parameter, fₚ⁻¹ is the second private key, s is the procedure parameter, and the third truncated polynomial ring is Zₚ[X]/X^{N}−1.

With reference to the fourth possible implementation manner of the fourth aspect, in a sixth possible implementation manner of the fourth aspect, the decryption unit calculates on the first truncated polynomial ring modulo the first system parameter according to the procedure parameter and the third private key to obtain the first random polynomial, and is specifically configured to:

calculate on the first truncated polynomial ring according to sₚ=s(mod p) and r₁=(s−sₚ)G to obtain the first random polynomial, where s is the procedure parameter, q₁ is the first system parameter, p is the third system parameter, G is the third private key, and the first truncated polynomial ring is Z_{q}_{₁}[X]X^{N}−1.

With reference to the third possible implementation manner of the fourth aspect, in a seventh possible implementation manner of the fourth aspect, the decryption unit calculates on the second truncated polynomial ring modulo the second system parameter according to the first random polynomial, the second random polynomial, the second ciphertext, and the second public key to obtain the plaintext information, and is specifically configured to:

calculate on the second truncated polynomial ring according to M=c₂−r₁h₂−r₂ to obtain the plaintext information, where c₂ is the second ciphertext, r₁ is the first random polynomial, r₂ is the second random polynomial, and h₂ is the second public key.

With reference to the second possible implementation manner of the fourth aspect, in an eighth possible implementation manner of the fourth aspect, the first private key is a third random polynomial, the second private key is an inverse element of the third random polynomial on the third truncated polynomial ring modulo the third system parameter, and the third private key is obtained through calculation according to an inverse element of the third system parameter and an inverse element of a fourth random polynomial on the first truncated polynomial ring modulo the first system parameter.

With reference to the eighth possible implementation manner of the fourth aspect, in a ninth possible implementation manner of the fourth aspect, the third private key is obtained through calculation on the first truncated polynomial modulo the first system parameter according to G=p⁻¹ g^{q}₁⁻¹, where p⁻¹ is an inverse element of the third system parameter modulo the first system parameter, q₁ is the first system parameter, g_{q}_{₁}⁻¹ is an inverse element of the fourth random polynomial on the first truncated polynomial ring modulo the first system parameter, and g is the fourth random polynomial.

According to the public-key encrypted communication manner in the embodiments of the present invention, a first device encrypts random information according to a first public key to obtain a first ciphertext, and encrypts plaintext information according to a second public key to obtain a second ciphertext, where the plaintext information is unencrypted data to be sent by the first device to a second device, the first public key is represented in a form of a polynomial, the first public key is obtained through calculation on a truncated polynomial ring according to system parameters, the second public key is represented in a form of a polynomial, the second public key is randomly selected on a truncated polynomial ring, and the random information is randomly selected on a truncated polynomial ring; and the first device sends the first ciphertext and the second ciphertext to the second device. This is equivalent to using random information as a shared key, encrypting the random information, and then using a public key and the random information to encrypt plaintext information, thereby achieving a public-key encrypted communication manner with higher security.

### BRIEF DESCRIPTION OF DRAWINGS

To describe the technical solutions in the embodiments of the present invention more clearly, the following briefly introduces the accompanying drawings required for describing the embodiments or the prior art. Apparently, the accompanying drawings in the following description show some embodiments of the present invention, and persons of ordinary skill in the art may still derive other drawings from these accompanying drawings without creative efforts.

FIG. 1 is a flowchart of Embodiment 1 of a method for public-key encrypted communication according to the present invention;

FIG. 2 is a flowchart of Embodiment 2 of a method for public-key encrypted communication according to the present invention;

FIG. 3 is a flowchart of Embodiment 3 of a method for public-key encrypted communication according to the present invention;

FIG. 4 is a schematic processing diagram of an optional implementation manner of step 300 in the method shown in FIG. 3;

FIG. 5 is a schematic processing diagram of an optional implementation manner of step 301 in the method shown in FIG. 3;

FIG. 6 is a schematic processing diagram of an optional implementation manner of step 303 and step 304 in the method shown in FIG. 3;

FIG. 7 is a schematic structural diagram of Embodiment 1 of an apparatus for public-key encrypted communication according to the present invention; and

FIG. 8 is a schematic structural diagram of Embodiment 2 of an apparatus for public-key encrypted communication according to the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

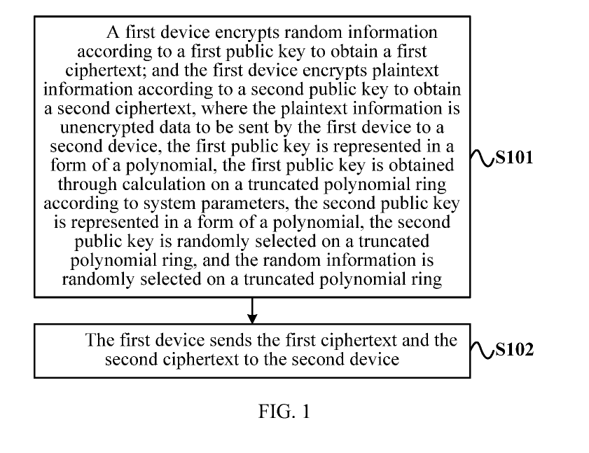

FIG. 1 is a flowchart of Embodiment 1 of a method for public-key encrypted communication according to the present invention. As shown in FIG. 1, the method in this embodiment may include:

S101: A first device encrypts random information according to a first public key to obtain a first ciphertext; and the first device encrypts plaintext information according to a second public key to obtain a second ciphertext, where the plaintext information is unencrypted data to be sent by the first device to a second device, the first public key is represented in a form of a polynomial, the first public key is obtained through calculation on a truncated polynomial ring according to system parameters, the second public key is represented in a form of a polynomial, the second public key is randomly selected on a truncated polynomial ring, and the random information is randomly selected on a truncated polynomial ring.

S102: The first device sends the first ciphertext and the second ciphertext to the second device.

In various implementation manners of the method for public-key encrypted communication provided in the present invention, devices at a transmit end and a receive end for public key communication may be respectively referred to as a first device and a second device, and unencrypted data to be sent by the first device to the second device during public key communication may be referred to as plaintext information. The first public key and the second public key may be generated by a key generation device for the public key communication. The key generation device may be the second device or another trusted third-party device. Before sending encrypted data to the second device, the first device acquires, from the key generation device, the first public key and the first public key that are required for encrypted communication with the second device, that is, a public key certificate of the second device. The key generation device also generates a first private key, a second private key, and a third private key, which are paired with the first public key and the second public key. Information about the public keys is stored in a public key certificate issued by a public key infrastructure (Public Key Infrastructure, PKI for short).

The first public key may be represented in a form of a polynomial. The first public key may be calculated on a truncated polynomial ring according to system parameters.

System parameters refer to a group of parameters preset by the key generation device, the first device at the transmit end, and the second device at the receive end based on consideration of security and calculation efficiency in a process of public key communication. A truncated polynomial ring refers to a set of univariate (N−1)^{th}-degree polynomials whose coefficients are integers. The truncated polynomial ring used to calculate the first public key may be determined according to the system parameters used in this public key communication.

The second public key may be represented in a form of a polynomial. The second public key is randomly selected on a truncated polynomial ring.

The truncated polynomial ring used to select the second public key may be determined according to the system parameters used in this public key communication. The random information may be randomly selected on a truncated polynomial ring by the first device according to requirements on security and encryption efficiency, that is, the random information may be any univariate polynomial. Coefficients of the univariate polynomial may constitute a vector, and a norm value of the vector of the coefficients is inversely proportional to encryption efficiency. Therefore, the first device may preferably use a univariate polynomial whose vector of coefficients has the smallest norm as the random information.

The first ciphertext obtained by the first device by using the first public key to encrypt the random information and the second ciphertext obtained by the first device by encrypting the plaintext information according to the second public key and the random information are a pair of polynomials.

That the first device encrypts the random information according to the first public key to obtain the first ciphertext is similar to that two communication parties first negotiate a shared key and insert the shared key into a type of one-way trapdoor function, so as to implement probabilistic encryption. According to the encryption manner for obtaining the first ciphertext, the random information is carried. The random information is equivalent to the shared key of the two communication parties. That the first device encrypts the plaintext information according to the second public key to obtain the second ciphertext is similar to using a shared key to implement one-time pad encryption. The second ciphertext carries the plaintext information. According to the encryption mode for obtaining the second ciphertext, the plaintext information is not leaked. It can be proved by using a mathematical method that the public key communication method in the present invention has higher security than an NTRU algorithm in the prior art. A security assessment method may be described as follows: In a particular attack mode, an attacker randomly selects two plaintexts m₁ and m₂, and by means of a cryptographic algorithm, a plaintext m_{b} is randomly selected from the two plaintexts and encrypted into a ciphertext c, where b is 1 or 2. If the attacker can determine b=1 or b=2 according to c with a non-negligible probability, which is equivalent to that the attacker correctly guesses which plaintext is encrypted into the ciphertext c, the attacker successfully breaks semantic security of the encryption algorithm. The foregoing method is used to verify security of the encryption manner in the present invention; because in the present invention, encryption is performed twice by constructing two polynomial-based one-way trapdoor functions, the probability that an attacker breaks semantic security of the algorithm is negligible, while the probability that semantic security of the NTRU encryption algorithm in the prior art is broken is non-negligible. Therefore, it can be proved by using a mathematical method that the present invention has higher security compared with the prior art.

According to the public-key encrypted communication manner in this embodiment of the present invention, a first device encrypts random information according to a first public key to obtain a first ciphertext, and encrypts plaintext information according to a second public key to obtain a second ciphertext, where the plaintext information is unencrypted data to be sent by the first device to a second device, the first public key is represented in a form of a polynomial, the first public key is obtained through calculation on a truncated polynomial ring according to system parameters, the second public key is represented in a form of a polynomial, the second public key is randomly selected on a truncated polynomial ring, and the random information is randomly selected on a truncated polynomial ring; and the first device sends the first ciphertext and the second ciphertext to the second device. This is equivalent to using random information as a shared key, encrypting the random information, and then using a public key and the random information to encrypt plaintext information, thereby achieving a public-key encrypted communication manner with higher security.

Optionally, Embodiment 1 of the method shown in FIG. 1 includes an optional implementation manner, which is different from the method shown in FIG. 1 in that:

the random information in S101 may include a first random polynomial and a second random polynomial.

Correspondingly, the performing, by a first device, encrypting random information according to a first public key n to obtain a first ciphertext in S101 may specifically include:

S101-1: The first device calculates on a first truncated polynomial ring modulo a first system parameter according to the first public key, the first random polynomial, and the second random polynomial to obtain the first ciphertext.

The plaintext information in S101 may be represented as a polynomial on a second truncated polynomial ring modulo a second system parameter.

Correspondingly, the encrypting, by the first device, plaintext information according to a second public key to obtain a second ciphertext in S101 may specifically include:

S101-2: The first device calculates on the second truncated polynomial ring modulo the second system parameter according to the second public key, the first random polynomial, the second random polynomial, and the plaintext information to obtain the second ciphertext.

The first public key in S101-1 may be obtained through calculation on the first truncated polynomial ring by the key generation device according to the first system parameter, a third random polynomial, and a fourth random polynomial. The third random polynomial and the fourth random polynomial may be randomly selected by the key generation device. A value range of the third random polynomial should satisfy that the third random polynomial has an inverse element on both the first truncated polynomial ring modulo the first system parameter and a third truncated polynomial ring modulo a third system parameter, and a value range of the fourth random polynomial is a polynomial having an inverse element on the first truncated polynomial ring.

The second public key in S101-2 may be randomly selected by the key generation device, and a value range of the second public key is any polynomial on the second truncated polynomial ring.

For example, the first public key may be obtained through calculation on the first truncated polynomial ring according to h₁=pf_{q}_{₁}⁻¹g, where h₁ is the first public key, p is the third system parameter, f is the third random polynomial, f_{q}_{₁}⁻¹ is an inverse element of the third random polynomial on the first truncated polynomial ring modulo the first system parameter, g is the fourth random polynomial, and the first truncated polynomial ring is Z_{q}_{₁}[X]/X^{N}−1.

The first ciphertext in S101-1 may be obtained through calculation on the first truncated polynomial ring according to c₁=r₁h₁+r₂, where h₁ is the first public key, r₁ is the first random polynomial, r₂ is the second random polynomial, the first truncated polynomial ring is Z_{q}_{₁}[X]/X^{N}−1, and q₁ is the first system parameter.

The second ciphertext in S101-2 may be obtained through calculation on the second truncated polynomial ring according to c₂=r₁h₂+r₂+M, where h₂ is the second public key, r₁ is the first random polynomial, r₂ is the second random polynomial, the second truncated polynomial ring is Z_{q}_{₂}[X]/X^{N}−1, and q₂ is the second system parameter.

In the foregoing implementation manner, the first system parameter in S101-1, the second system parameter in S101-2, and a fourth system parameter N may all be preset by the key generation device according to requirements on security and key generation performance. Optionally, for security of the highest level, 503 may be selected as the fourth system parameter N. Preferably, the first system parameter and the second system parameter are two odd primes, and the second system parameter is equal to the first system parameter plus 2, that is, q₂=q₁+2. For example, q₁ is 239, and q₂ is 241; or q₁ is 269, and q₂ is 271.

It should be noted that a truncated polynomial ring refers to a set of univariate (N−1)^{th}-degree polynomials whose coefficients are integers, and can be generally represented as Z[X]/X^{N}−1; the first truncated polynomial ring Z_{q}_{₁}[X]/X^{N}−1 modulo the first system parameter in S101-1 refers to a truncated polynomial ring obtained from the truncated polynomial ring modulo the first system parameter. Similarly, the third truncated polynomial ring Zₚ[X]/X^{N}−1 modulo the third system parameter refers to a truncated polynomial ring obtained from the truncated polynomial ring modulo the third system parameter. In addition, a modulo operation on a polynomial refers to division of a polynomial by a modulus polynomial, and a result of the modulo operation on the polynomial refers to a remainder polynomial obtained through division of the polynomial by the modulus polynomial. For example, an operation result of a polynomial modulo a polynomial X^{N}−1 is a remainder polynomial of division of the polynomial by the polynomial X^{N}−1.

Further, to reduce the quantity of calculations, for the modulo operation of the present invention, only modulo operation results within an absolute minimum complete residue system are used. For example, operation results within a minimum complete residue system of a natural number modulo 3 are 1, 0, and 1 instead of 0, 1, and 2. Correspondingly, when the first random polynomial and the second random polynomial are selected, a polynomial whose coefficient is +1 or 1 or 0 may be selected on the truncated polynomial ring Z[X]/X^{N}−1, where a quantity of terms whose coefficient is +1 is about N/3, a quantity of terms whose coefficient is −1 is about N/3−1, and coefficients of the rest of the terms are 0.

In this embodiment, the first device sends the first ciphertext and the second ciphertext to the second device, so that the second device performs decryption according to the first ciphertext and the second ciphertext as well as the first private key, the second private key, and the third private key that correspond to the first public key and the second public key to obtain the plaintext information. This is equivalent to using random information as a shared key, encrypting the random information, and then using a public key and the random information to encrypt plaintext information, thereby achieving a public-key encrypted communication manner with higher security. In addition, compared with other encryption manners whose security can be proved, the encryption method of the present invention has some improvements in aspects of encryption speed, decryption speed, and ciphertext expansion ratio.

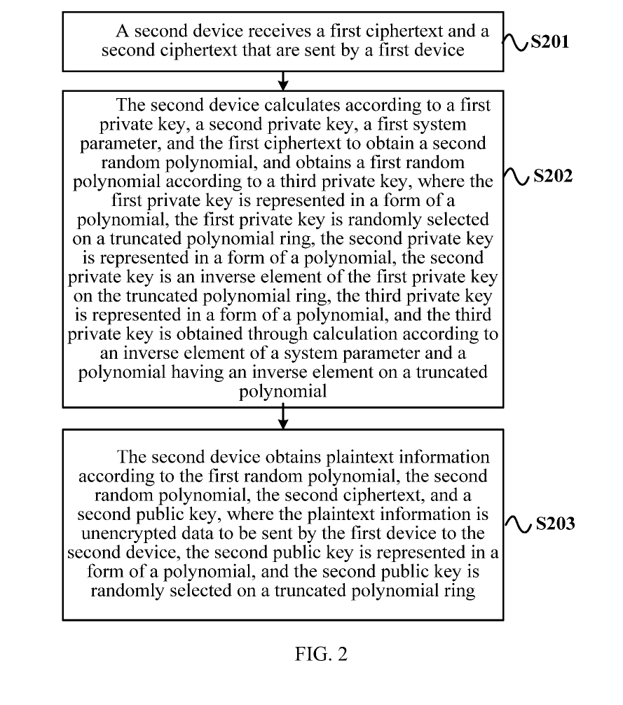

FIG. 2 is a flowchart of Embodiment 2 of a method for public-key encrypted communication according to the present invention. As shown in FIG. 2, the method in this embodiment may include:

S201: A second device receives a first ciphertext and a second ciphertext that are sent by a first device.

S202: The second device calculates according to a first private key, a second private key, a first system parameter, and the first ciphertext to a second random polynomial, and obtains a first random polynomial according to a third private key, where the first private key is represented in a form of a polynomial, the first private key is randomly selected on a truncated polynomial ring, the second private key is represented in a form of a polynomial, the second private key is an inverse element of the first private key on the truncated polynomial ring, the third private key is represented in a form of a polynomial, and the third private key is obtained through calculation according to an inverse element of a system parameter and a polynomial having an inverse element on a truncated polynomial.

S203: The second device obtains plaintext information according to the first random polynomial, the second random polynomial, the second ciphertext, and a second public key, where the plaintext information is unencrypted data to be sent by the first device to the second device, the second public key is represented in a form of a polynomial, and the second public key is randomly selected on a truncated polynomial ring.

The first ciphertext and the second ciphertext that are sent by the first device and received by the second device are encrypted data, and the first ciphertext and the second ciphertext may be a pair of polynomials.

The first private key may be represented in a form of a polynomial, and the first private key may be randomly selected on a truncated polynomial ring; the second private key may be represented in a form of a polynomial, and the second private key may be an inverse element of the first private key on the truncated polynomial ring; the third private key may be represented in a form of a polynomial, and the third private key may be obtained through calculation according to an inverse element of a system parameter and a polynomial having an inverse element on a truncated polynomial.

System parameters refer to a group of parameters preset by a key generation device, the first device at the transmit end, and the second device at the receive end based on consideration of security and calculation efficiency in a process of public key communication. A truncated polynomial ring refers to a set of univariate (N−1)^{th}-degree polynomials whose coefficients are integers.

The truncated polynomial ring used to select the first private key, the truncated polynomial ring used to select the second private key, and the truncated polynomial ring used to select the third private key may be separately determined according to the system parameters used in this public key communication. Before receiving encrypted data sent by the first device, the second device acquires, from the key generation device for public key communication, private key information and public key information that are required for decryption. The key generation device may be the second device or another trusted third-party device. The first private key, the second private key, the third private key, and the second public key may be generated by the key generation device for public key communication. The first private key, the second private key, and the third private key that are generated by the key generation device match the first public key and the second public key.

The process in which the second device calculates according to the first private key, the second private key, the first system parameter, and the first ciphertext to obtain the second random polynomial and obtains the first random polynomial according to the third private key is similar to that two communications parties negotiate a shared key, obtain the second random polynomial corresponding to a one-way trapdoor function through decryption according to the first private key, the second private key, and the first ciphertext, and obtain the first random polynomial through decryption according to the third private key, which is equivalent to acquiring the shared key of the two communications parties from the first ciphertext. The one-way trapdoor function is used by the first device during data encryption, and the system parameter is the same as a system parameter used by the first device during data encryption.

Therefore, the second device can calculate according to the one-way trapdoor function used by the first device in the encryption process, the first private key, the second private key, the first system parameter, the third private key, and the first ciphertext to obtain the second random polynomial and the first random polynomial. The second device can calculate according to the one-way trapdoor function used by the first device in the encryption process, the first random polynomial, the second random polynomial, the second public key, and the second ciphertext to obtain the plaintext information.

Security of the method shown in this embodiment of the present invention is the same as that of the method shown in FIG. 1. For details, refer to the security proving process in Embodiment 1, which is not described in detail herein again.

Optionally, Embodiment 2 of the method shown in FIG. 2 includes an optional implementation manner, which is different from the method shown in FIG. 2 in that:

The calculating, by the second device, according to a first private key, a second private key, and the first ciphertext in S202 to obtain a second random polynomial may specifically include:

S202-1: The second device calculates on a first truncated polynomial ring modulo a first system parameter according to the first ciphertext and the first private key to obtain a procedure parameter.

S202-2: The second device obtains the second random polynomial on a third truncated polynomial ring modulo a third system parameter according to the procedure parameter and the second private key.

The obtaining a first random polynomial according to a third private key in S202 may specifically include:

S202-3: The second device calculates on the first truncated polynomial ring modulo the first system parameter according to the procedure parameter and the third private key to obtain the first random polynomial.

The obtaining, by the second device, plaintext information according to the first random polynomial, the second random polynomial, the second ciphertext, and a second public key in S203 may specifically include:

S203-1: The second device calculates on a second truncated polynomial ring modulo a second system parameter according to the first random polynomial, the second random polynomial, the second ciphertext, and the second public key to obtain the plaintext information.

The first private key is a third random polynomial, the second private key is an inverse element of the third random polynomial on the third truncated polynomial ring modulo the third system parameter, and the third private key is obtained through calculation according to an inverse element of the third system parameter and an inverse element of a fourth random polynomial on the first truncated polynomial ring modulo the first system parameter.

The third random polynomial and the fourth random polynomial are randomly selected by the key generation device. A value range of the third random polynomial is a polynomial having an inverse element on both the first truncated polynomial ring and the third truncated polynomial ring modulo the third system parameter, and a value range of the fourth random polynomial is a polynomial having an inverse element on the first truncated polynomial ring modulo the first system parameter.

It should be noted that the foregoing system parameters, the truncated polynomial rings corresponding to the system parameters, and requirements on results of modulo operations are the same as those in Embodiment 1, and the details are not described herein again.

For example, the procedure parameter in S202-1 may be obtained through calculation on the first truncated polynomial ring modulo the first system parameter according to s=fc₁, where s is the procedure parameter, f is the first private key, and c₁ is the first ciphertext.

The second random polynomial in S202-2 may be obtained through calculation on the third truncated polynomial ring modulo the third system parameter according to sₚ=s(mod p) and r₂=sₚfₚ⁻¹, where r₂ is the second random polynomial, p is the third system parameter, fₚ⁻¹ is the second private key, s is the procedure parameter, and the third truncated polynomial ring is Zₚ[X]/X^{N}−1.

The first random polynomial in S202-3 may be obtained through calculation on the first truncated polynomial ring according to sₚ=s(mod p) and r₁=(s−sₚ)G, where s is the procedure parameter, q₁ is the first system parameter, p is the third system parameter, G is the third private key, and the first truncated polynomial ring is Z_{q}_{₁}[X]/X^{N}−1.

The third private key may be obtained through calculation on the first truncated polynomial ring modulo the first system parameter according to G=p⁻¹g_{q}_{₁}⁻¹, where p⁻¹ is an inverse element of the third system parameter modulo the first system parameter, q₁ is the first system parameter, g is the fourth random polynomial, and g_{q}_{₁}⁻¹ is an inverse element of the fourth random polynomial on the first truncated polynomial ring.

The plaintext information in S203-1 may be obtained through calculation on the second truncated polynomial ring according to M=c₂−r₁h₂−r₂, where c₂ is the second ciphertext, r₁ is the first random polynomial, r₂ is the second random polynomial, h₂ is the second public key, and q₂ is the second system parameter.

In this embodiment, the second device receives a first ciphertext and a second ciphertext that are sent by a first device, and calculates according to a first private key, a second private key, a first system parameter, a third private key, and the first ciphertext to obtain a second random polynomial and a first random polynomial, and then obtains plaintext information according to the first random polynomial, the second random polynomial, the second ciphertext, and a second public key. This achieves a public-key encrypted communication manner whose security can be proved. In addition, compared with other encryption manners whose security can be proved, the encryption method of this application has some improvements in aspects of encryption speed, decryption speed, and ciphertext expansion ratio.

The following describes in further detail the technical solutions of the method embodiments shown in FIG. 1 and FIG. 2 by using several specific embodiments.

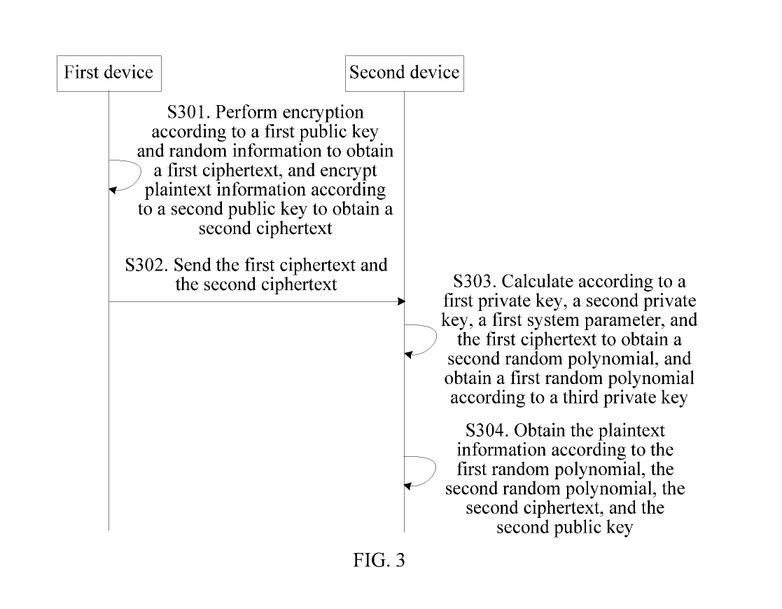

FIG. 3 is a flowchart of Embodiment 3 of a method for public-key encrypted communication according to the present invention. This embodiment describes a process of interaction between a first device at a transmit end and a second device at a receive end that use the methods for public-key encrypted communication shown in FIG. 1 and FIG. 2. As shown in FIG. 3, the method in this embodiment may include:

S301: A first device performs encryption according to a first public key and random information to obtain a first ciphertext; and the first device encrypts plaintext information according to a second public key to obtain a second ciphertext.

The plaintext information is unencrypted data to be sent by the first device to a second device, and the random information is randomly selected on a truncated polynomial ring.

The first public key and the second public key are generated by a key generation device, and the key generation device may be the second device or another trusted third-party device. The first public key is represented in a form of a polynomial, and the first public key is obtained through calculation on a truncated polynomial ring according to system parameters. The second public key is represented in a form of a polynomial, and the second public key is randomly selected on a truncated polynomial ring.

Optionally, the first random polynomial may be represented as a polynomial on a second truncated polynomial ring modulo a second system parameter.

S302: The first device sends the first ciphertext and the second ciphertext to the second device.

S303: The second device calculates according to a first private key, a second private key, a first system parameter, and the first ciphertext to obtain a second random polynomial, and obtains a first random polynomial according to a third private key.

The first private key, the second private key, and the third public key are generated by a key generation device, and the key generation device may be the second device or another trusted third-party device. The first private key may be represented in a form of a polynomial, and the first private key may be randomly selected on a truncated polynomial ring; the second private key may be represented in a form of a polynomial, and the second private key may be an inverse element of the first private key on the truncated polynomial ring; the third private key may be represented in a form of a polynomial, and the third private key may be obtained through calculation according to an inverse element of a system parameter and a polynomial having an inverse element on a truncated polynomial.

S304: The second device obtains the plaintext information according to the first random polynomial, the second random polynomial, the second ciphertext, and the second public key.

Further, before step 301, the method further includes:

S300: The key generation device calculates the first public key, the second public key, the first private key, the second private key, and the third private key according to the first system parameter, a second system parameter, a third system parameter, and a fourth system parameter.

The first public key may be represented in a form of a polynomial, and the first public key is obtained through calculation on a truncated polynomial ring according to system parameters; the second public key is represented in a form of a polynomial, and the second public key is randomly selected on a truncated polynomial ring;

the first private key is represented in a form of a polynomial, the first private key is randomly selected on a truncated polynomial ring, the second private key is represented in a form of a polynomial, the second private key is an inverse element of the first private key on the truncated polynomial ring, the third private key is represented in a form of a polynomial, and the third private key is obtained through calculation according to an inverse element of a system parameter and a polynomial having an inverse element on a truncated polynomial.

Optionally, the first device may search for the public keys of the second device by using a PKI.

This embodiment has the same technical solution and technical effect as those of the methods for public-key encrypted communication shown in FIG. 1 and FIG. 2, and the details are not described herein again.

In this embodiment, the first device sends the first ciphertext and the second ciphertext to the second device, and the second device performs decryption according to the first ciphertext and the second ciphertext as well as the first private key, the second private key, and the third private key that correspond to the first public key and the second public key to obtain the plaintext information, thereby achieving a public-key encrypted communication manner whose security can be proved.

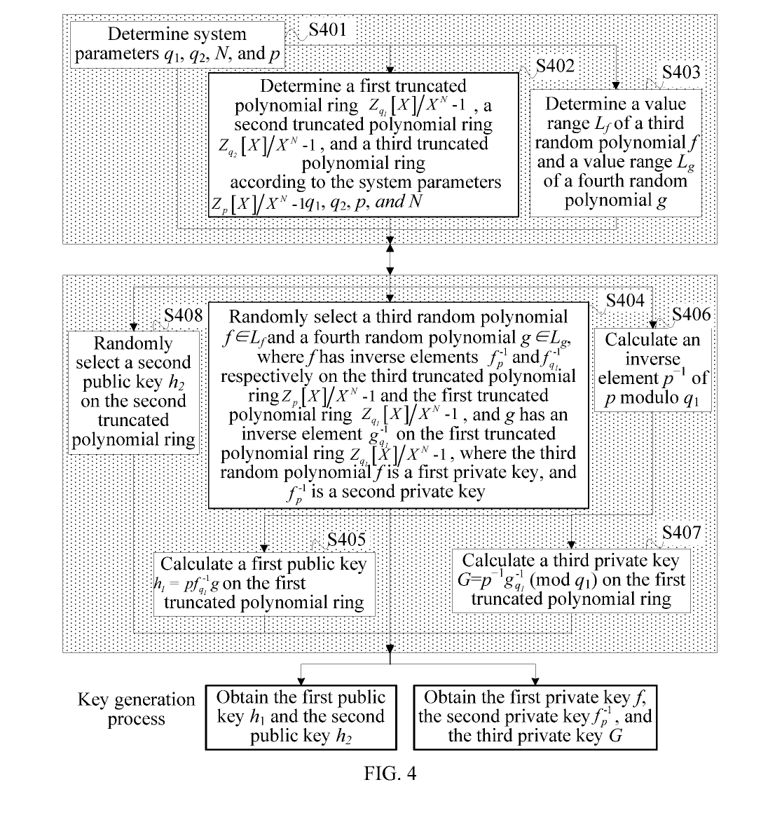

FIG. 4 is a schematic processing diagram of an optional implementation manner of step 300 in the method shown in FIG. 3. As shown in FIG. 4, this embodiment is executed by a key generation device. The key generation device may be the second device or the third-party device. The method in this embodiment may include:

S401: Determine system parameters q₁, q₂, p, and N.

q₁ is the first system parameter, q₂ is the second system parameter, p is the third system parameter, Nis the fourth system parameter, and the system parameters are set according to security and encryption performance. Preferably, among the system parameters q₁, q₂, p, and N determined in S401, q₁ and q₂ may preferably be two odd primes, and q₂=q₁+2. For example, q₁ may be 239, and q₂ may be 241; or q₁ may be 269, and q₂ may be 271. In addition, for security of the highest level, N may preferably be 503.

S402: Determine a first truncated polynomial ring Z_{q}_{₁}[X]/X^{N}−1, a second truncated polynomial ring Z_{q}_{₂}[X]/X^{N}−1, and a third truncated polynomial ring Zₚ[X]/X^{N}−1 according to the system parameters q₁, q₂, p, and N.

The first truncated polynomial ring is a set of truncated polynomials modulo q₁, the second truncated polynomial ring is a set of truncated polynomials modulo q₂, and the third truncated polynomial ring is a set of truncated polynomials modulo p.

S403: Determine a value range L_{f} of a third random polynomial f and a value range L_{g} of a fourth random polynomial g.

The value range may be set according to requirements on security and encryption performance. For example, in order to achieve higher security of a private key, when the polynomial f is selected, a polynomial whose coefficient is +1 or −1 or 0 may be selected on a truncated polynomial ring Z[X]/X^{N}−1, where a quantity of terms whose coefficient is +1 is about N/3, a quantity of terms whose coefficient is +1 is about N/3−1, and coefficients of the rest of the terms are 0.

S404: Randomly select a third random polynomial _{f}εL_{f} and a fourth random polynomial gεL_{g}, where f has inverse elements fₚ⁻¹ and f_{q}_{₁}⁻¹ respectively on the third truncated polynomial ring Zₚ[X]/X^{N}−1 and the first truncated polynomial ring Z_{q}_{₁}[X]/X^{N}−1, and g has an inverse element g_{q}_{₁}⁻¹ on the first truncated polynomial ring Z_{q}_{₁}[X]/X^{N}−1.

The third random polynomial f is a first private key, and fₚ⁻¹ is a second private key.

S405: Calculate a first public key h₁=pf_{q}_{₁}⁻¹g on the first truncated polynomial ring.

S406: Calculate an inverse element p⁻¹ of p modulo q₁.

S407: Calculate a third private key G=p⁻¹g_{q}_{₁}⁻¹ on the first truncated polynomial ring.

S408: Randomly select a second public key h₂ on the second truncated polynomial ring.

After step 408, the key generation device publishes q₁, q₂, p, and N, where h₁ and h₂ are public keys of the second device.

This embodiment has the same technical solution and technical effect as those of the methods for public-key encrypted communication shown in FIG. 1 to FIG. 3, and the details are not described herein again.

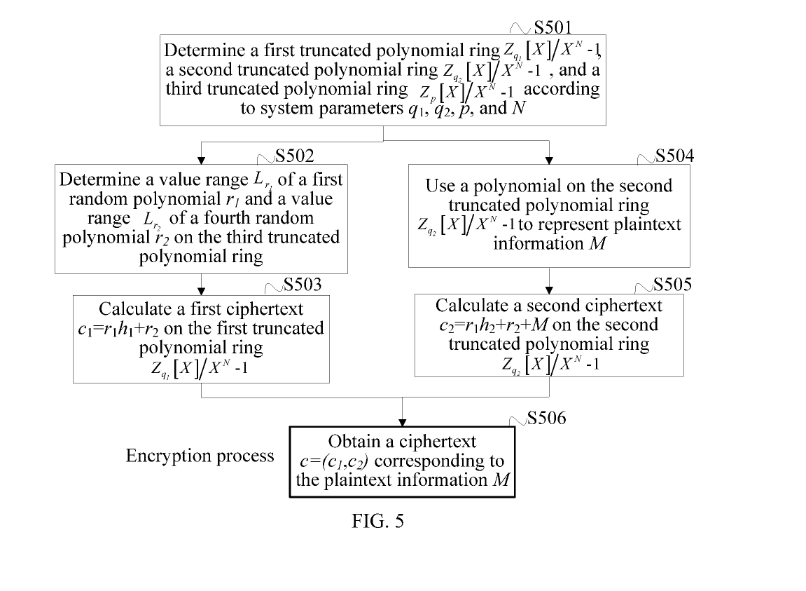

FIG. 5 is a schematic processing diagram of an optional implementation manner of step 301 in the method shown in FIG. 3. As shown in FIG. 5, this embodiment is executed by a first device. The method in this embodiment may include:

S501: Determine a first truncated polynomial ring Z_{q}_{₁}[X]/X^{N}−1, a second truncated polynomial ring Z_{q}_{₂}[X]/X^{N}−1, and a third truncated polynomial ring Zₚ[X]/X^{N}−1 according to system parameters q₁, q₂, p, and N

q₁ is the first system parameter, q₂ is the second system parameter, p is the third system parameter, N is the fourth system parameter, and the system parameters q₁, q₂, p, and N may be obtained by using the method shown in FIG. 4. The first truncated polynomial ring is a set of truncated polynomials modulo q₁, the second truncated polynomial ring is a set of truncated polynomials modulo q₂, and the third truncated polynomial ring is a set of truncated polynomials modulo p.

S502: Determine a value range Lᵣ_{₁} of a first random polynomial r₁ and a value range Lᵣ_{₂} of a fourth random polynomial r₂ on the third truncated polynomial ring.

The value range may be set according to requirements on security and encryption performance.

S503: Calculate a first ciphertext c₁=r₁h₁+r₂ on the first truncated polynomial ring Z_{q}_{₁}[X]/X^{N}−1.

h₁ is a first public key, and h₁ may be obtained by using the method shown in FIG. 4.

S504: Use a polynomial on the second truncated polynomial ring Z_{q}_{₂}[X]/X^{N}−1 to represent plaintext information M.

S505: Calculate a second ciphertext c₂=r₁h₂+r₂+M on the second truncated polynomial ring Q_{q}_{₂}[X]/X^{N}−1.

h₂ is a second public key, and the system parameter h₂ may be obtained by using the method shown in FIG. 4.

S506: Obtain a ciphertext c(c₁,c₂) corresponding to the plaintext information M.

This embodiment has the same technical solution and technical effect as those of the methods for public-key encrypted communication shown in FIG. 1 to FIG. 4, and the details are not described herein again.

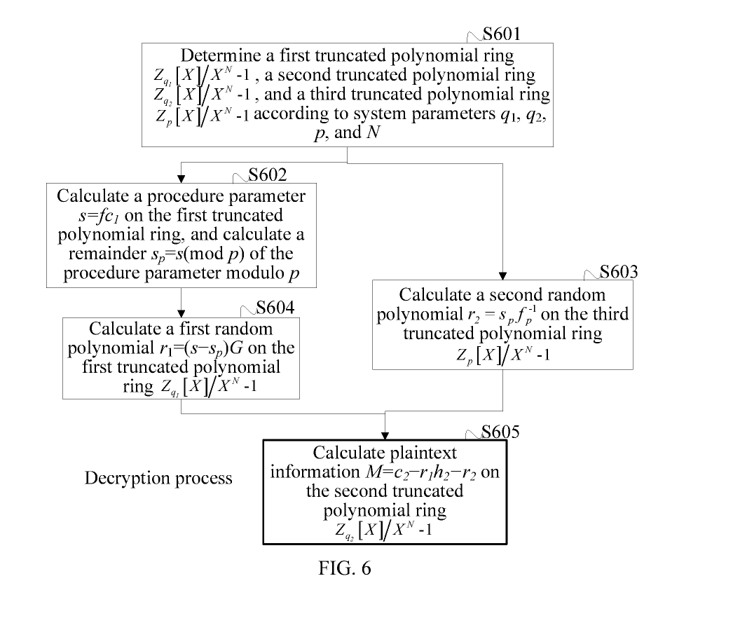

FIG. 6 is a schematic processing diagram of an optional implementation manner of step 303 and step 304 in the method shown in FIG. 3. As shown in FIG. 6, this embodiment is executed by a second device. The method in this embodiment may include:

S601: Determine a first truncated polynomial ring Z_{q}_{₁}[X]/X^{N}−1, a second truncated polynomial ring Z_{q}_{₂}[X]/X^{N}−1, and a third truncated polynomial ring Zₚ[X]/X^{N}−1 according to system parameters q₁, q₂, p, and N.

q₁ is the first system parameter, q₂ is the second system parameter, p is the third system parameter, N is the fourth system parameter, and the system parameters q₁, q₂, p, and N may be obtained by using the method shown in FIG. 4. The first truncated polynomial ring is a set of truncated polynomials modulo q₁, the second truncated polynomial ring is a set of truncated polynomials modulo q₂, and the third truncated polynomial ring is a set of truncated polynomials modulo p.

S602: Calculate a procedure parameter s=fc₁ on the first truncated polynomial ring, and calculate a remainder sₚ=s(mod p) of the procedure parameter modulo p.

f is the first private key, c₁ is the first ciphertext, and f and c₁ may be obtained by using the method shown in FIG. 1 to FIG. 4.

S603: Calculate a second random polynomial r₂=sₚfₚ⁻¹ on the third truncated polynomial ring.

fₚ⁻¹ is the second private key, and fₚ⁻¹ may be obtained by using the method shown in FIG. 4.

S604: Calculate a first random polynomial r₁=(s−sₚ)G on the first truncated polynomial ring.

G is the third private key, and G may be obtained by using the method shown in FIG. 4.

S605: Calculate plaintext information M=c₂−r₁h₂−r₂ on the second truncated polynomial ring.

h₂ is the second public key, c₂ is the second ciphertext, and h₂ and c₂ may be obtained by using the method shown in FIG. 4.

This embodiment has the same technical solution and technical effect as those of the methods for public-key encrypted communication shown in FIG. 1 to FIG. 5, and the details are not described herein again.

Optionally, an embodiment of the present invention further provides an optional implementation manner, which is different from the methods shown in FIG. 4 to FIG. 6 in that step S405 in the method shown in FIG. 4 may be implemented by using a method shown in S405-1.

S405-1: Calculate a first public key h₁=f_{q}_{₁}⁻¹g on the first truncated polynomial ring.

f_{q}⁻¹ is an inverse element of the third random on the first truncated polynomial ring modulo the first system parameter, g is the fourth random polynomial, q₁ is the first system parameter, and the first truncated polynomial ring is Z_{q}_{₁}[X]/X^{N}−1.

Correspondingly, step S503 in the method shown in FIG. 5 may be implemented by using a method shown in S503-1.

S503: Calculate a first ciphertext c₁=r₁h₁+r₂ on the first truncated polynomial ring Z_{q}_{₁}[X]/X^{N}−1.

h₁ is a first public key, and h₁ may be obtained by using the method shown in step S405-1.

Other steps of the technical solution of this embodiment are the same as those of the method for public-key encrypted communication shown in FIG. 4 to FIG. 6, and the details are not described herein again.

Moreover, in some scenarios in which resources are limited, the encryption manner provided in the present invention can still provide higher security. Compared with other existing encryption manners whose security can be proved, the encryption method of the present invention has some advantages in aspects of encryption speed, decryption speed, and ciphertext expansion ratio. A specific comparison is as follows:

The encryption speed of the method for public-key encrypted communication in the present invention is higher than that of the NTRU algorithm. For ease of comparison between the quantities of calculations required for encryption work by the present invention and the NTRU algorithm, it is assumed that a to-be-encrypted plaintext has a length of N log₂p log₂q₂ bits. In the present invention, a plaintext having a length of N log₂q₂ bits can be encrypted each time; therefore, encryption needs to be performed for log₂p times. In the present invention, during each encryption, c₁=r₁h₁+r₂ needs to be obtained through calculation first on the truncated polynomial ring Z_{q}_{₁}[X]/X^{N}−1 modulo q₁, and the quantity of calculations for addition can be ignored; therefore, about one polynomial multiplication operation on the ring Z_{q}_{₂}[X]/X^{N}−1 is required. Then c₂=r₁h₂+r₂+M is obtained through calculation on the truncated polynomial ring Z_{q}_{₂}[X]/X^{N}−1 modulo q₂; therefore, about one polynomial multiplication operation on the ring Z_{q}_{₂}[X]/X^{N}−1 is also required. Because q₂=q₁+2 herein, about two polynomial multiplication operations on the ring Z_{q}_{₁}[X]/X^{N}−1 are required. Therefore, to encrypt a plaintext having a length of N log₂p log₂q₂ bits, the solution of the present invention requires about 2 log₂p polynomial multiplication operations on the ring Z_{q}_{₁}[X]/X^{N}−1. The original NTRU algorithm can encrypt a plaintext having a length of N log₂p bits each time; therefore, to encrypt a plaintext having a length of N log₂p log₂q₂ bits, the NTRU requires log₂q₂≈log₂q₁ times of encryption. The NTRU requires calculation of c=φh+m on a ring Z_{q}[X]/X^{N}−1 for each encryption, the quantity of calculations of which is about one polynomial multiplication operation on the ring Z_{q}_{₁}[X]/X^{N}−1. Therefore, to encrypt a plaintext having a length of N log₂p log₂q₂ bits, the NTRU requires about log₂q₁ polynomial multiplication operations on the ring Z_{q}_{₁}[X]/X^{N}−1. To encrypt a plaintext having a given length, a ratio of the quantity of calculations required by the present invention to the quantity of calculations required by the NTRU algorithm is about 2 log₂p:log₂q₁. In a case in which the parameters are set to p=3 and q₁=239, the ratio is about 0.4, that is, the encryption speed of the present invention is about 2.5 times that of the NTRU.

In addition, the decryption speed of the method for public-key encrypted communication in the present invention is higher than that of the NTRU algorithm. For ease of comparison between the quantities of calculations required for decryption work by the present invention and the NTRU algorithm, it is assumed that plaintext information corresponding to a to-be-decrypted ciphertext has a length of N log₂p log₂q₂ bits. The present invention requires log₂p times of decryption, and each decryption requires two multiplication operations s=fc₁ and r₁=(s−sₚ)G on the ring Z_{q}_{₁}[X]/X^{N}−1, one multiplication operation r₂=sₚfₚ⁻¹ on the ring Zₚ[X]/X^{N}−1, and about one multiplication operation M=c₂−r₁h₂−r₂ on the ring Z_{q}_{₂}[X]/X^{N}−1, and one multiplication operation on the ring Zₚ[X]/X^{N}−1 is equivalent to log₂²p:log₂²q₁≈0.04 (given that p=3 and q₁=239) multiplication operations on the ring Z_{q}_{₁}[X]/X^{N}−1. Therefore, to decrypt a ciphertext corresponding to a plaintext having a length of N log₂p log₂q₂ bits, the present invention requires about 3.04 multiplication operations on the ring Z_{q}_{₁}[X]/X^{N}−1. Therefore, to decrypt a ciphertext corresponding to a plaintext having a length of N log₂p log₂q₂ bits, the present invention requires about 3.04 log₂p multiplication operations on the ring Z_{q}_{₁}[X]/X^{N}−1. To decrypt a ciphertext corresponding to a plaintext having a length of N log₂p log₂q₂ bits, the NTRU algorithm requires running a decryption algorithm for log₂q₂≈log₂q₁ times. The NTRU requires one multiplication operation a=fc on the ring Z_{q}[X]/X^{N}−1 and one multiplication operation m=fₚ⁻¹ a on a ring Zₚ[X]/X^{N}−1 for each decryption. Therefore, the NTRU requires about 1.04 multiplication operations on the ring Z_{q}_{₁}[X]/X^{N}−1 for each decryption. Therefore, to decrypt a ciphertext corresponding to a plaintext having a length of N log₂p log₂q₂ bits, the NTRU requires about 1.04 log₂q₁ multiplication operations on the ring Z_{q}_{₁}[X]/X^{N}−1. A ratio of the quantity of calculations required by the present invention to the quantity of calculations required by the NTRU is 3.04 log₂p:1.04 log₂q₁≈0.59 (given that p=3 and q₁=239). That is, to decrypt a ciphertext corresponding to a plaintext having a length of N log₂p log₂q₂ bits, the decryption speed of the present invention is about 1.70 times that of the NTRU.

In addition, the method for public-key encrypted communication in the present invention has a smaller ciphertext expansion ratio than that of the NTRU algorithm. If the length of a plaintext to be encrypted in the present invention is represented as N log₂q₂ bits, ciphertexts c₁ and c₂ obtained after encryption respectively have a length of N log₂q₁ bits and N log₂q₂ bits, and the ciphertext expansion ratio of the present invention is N(log₂q₁+log₂q₂):N log₂q₂<2:1. If the length of a plaintext in the NTRU is represented as N log₂p bits, a ciphertext obtained after encryption has a length of N log₂q bits, and the ciphertext expansion ratio of the NTRU is N log₂q:N log₂p=logₚq:1. In cases in which the parameters are set to p=3 and q=128, 256, and 512, ciphertext expansion ratios are about 4.42:1, 5.05:1, and 5.68:1 respectively. Therefore, compared with the NTRU, the present invention has a smaller ciphertext expansion ratio.

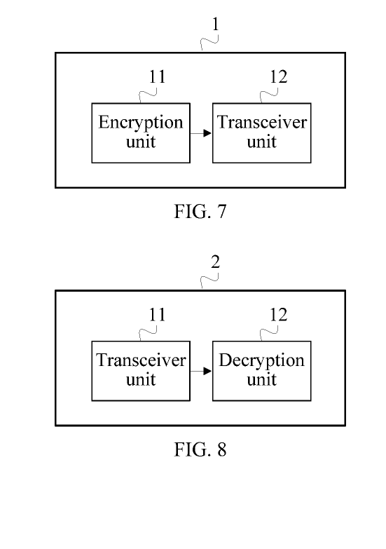

FIG. 7 is a schematic structural diagram of Embodiment 1 of an apparatus for public-key encrypted communication according to the present invention. The apparatus in this embodiment may be a first device, that is, a transmit end for public key communication. As shown in FIG. 7, the apparatus 1 in this embodiment may include: an encryption unit 11 and a transceiver unit 12, where the encryption unit 11 is configured to perform encryption according to a first public key and random information to obtain a first ciphertext, and is further configured to encrypt plaintext information according to a second public key to obtain a second ciphertext, where the plaintext information is unencrypted data to be sent by the first device to a second device, the first public key is represented in a form of a polynomial, the first public key is obtained through calculation on a truncated polynomial ring according to system parameters, the second public key is represented in a form of a polynomial, the second public key is randomly selected on a truncated polynomial ring, and the random information is randomly selected on a truncated polynomial ring; and the transceiver unit 12 is configured to send the first ciphertext and the second ciphertext to the second device.

Optionally, the random information includes a first random polynomial and a second random polynomial, and the encryption unit 11 is specifically configured to:

calculate on a first truncated polynomial ring modulo a first system parameter according to the first public key, the first random polynomial, and the second random polynomial to obtain the first ciphertext.

Correspondingly, the plaintext information is represented as a polynomial on a second truncated polynomial ring modulo a second system parameter, and the encryption unit 11 is further specifically configured to:

calculate on the second truncated polynomial ring modulo the second system parameter according to the second public key, the first random polynomial, the second random polynomial, and the plaintext information to obtain the second ciphertext.

The first public key is obtained through calculation on the first truncated polynomial ring modulo the first system parameter according to the first system parameter, a third random polynomial, and a fourth random polynomial, the third random polynomial has an inverse element on both the first truncated polynomial ring modulo the first system parameter and a third truncated polynomial ring modulo a third system parameter, and the fourth random polynomial has an inverse element on the first truncated polynomial ring modulo the first system parameter. The second public key is randomly selected on the second truncated polynomial ring.

Further, the encryption unit 11 is configured to calculate on the first truncated polynomial ring modulo the first system parameter according to the first public key, the first random polynomial, and the second random polynomial to obtain the first ciphertext, and is specifically configured to:

calculate on the first truncated polynomial ring according to c₁=r₁h₁+r₂ to obtain the first ciphertext, where h₁ is the first public key, r₁ is the first random polynomial, r₂ is the second random polynomial, the first truncated polynomial ring is Z_{q}_{₁}[X]/X^{N}−1, and q₁ is the first system parameter.

The encryption unit 11 is configured to calculate on the second truncated polynomial ring modulo the second system parameter according to the second public key, the first random polynomial, the second random polynomial, and the plaintext information to obtain the second ciphertext, and is specifically configured to:

calculate on the second truncated polynomial ring according to c₂=r₁h₂+r₂+M to obtain the second ciphertext, where h₂ is the second public key, r₁ is the first random polynomial, r₂ is the second random polynomial, the second truncated polynomial ring is Z_{q}_{₂}[X]/X^{N}−1, and q₂ is the second system parameter.

The first public key is obtained through calculation on the first truncated polynomial ring according to h₁=pf_{q}_{₁}⁻¹g, where p is the third system parameter, f is the third random polynomial, f_{q}_{₁}⁻¹ is an inverse element of the third random polynomial on the first truncated polynomial ring modulo the first system parameter, g is the fourth random polynomial, q₁ is the first system parameter, and the first truncated polynomial ring is Z_{q}_{₁}[X]/X^{N}−1; and the second public key is randomly selected on the second truncated polynomial ring, and the second truncated polynomial ring is Z_{q}_{₂}[X]/X^{N}−1.

The apparatus in this embodiment may be configured to execute the technical solutions of the method embodiments shown in FIG. 1 to FIG. 6. The implementation principle and technical effect of this embodiment are similar to those of the method embodiments shown in FIG. 1 to FIG. 6, and the details are not described herein again.

FIG. 8 is a schematic structural diagram of Embodiment 2 of an apparatus for public-key encrypted communication according to the present invention. The apparatus in this embodiment may be a second device, that is, a receive end for public key communication. As shown in FIG. 8, the apparatus 2 in this embodiment may include: a transceiver unit 11 and a decryption unit 12, where the transceiver unit 11 is configured to receive a first ciphertext and a second ciphertext that are sent by a first device; and the decryption unit 12 is configured to calculate according to a first private key, a second private key, and the first ciphertext to obtain a second random polynomial, and obtain a first random polynomial according to a third private key, where the first private key is represented in a form of a polynomial, the first private key is randomly selected on a truncated polynomial ring, the second private key is represented in a form of a polynomial, the second private key is an inverse element of the first private key on the truncated polynomial ring, the third private key is represented in a form of a polynomial, and the third private key is obtained through calculation according to an inverse element of a system parameter and a polynomial having an inverse element on a truncated polynomial, where the decryption unit 12 is further configured to obtain plaintext information according to the first random polynomial, the second random polynomial, the second ciphertext, and a second public key, where the plaintext information is unencrypted data to be sent by the first device to the second device, the second public key is represented in a form of a polynomial, and the second public key is randomly selected on a truncated polynomial ring.

Optionally, the decryption unit 12 is specifically configured to:

calculate on a first truncated polynomial ring modulo a first system parameter according to the first ciphertext and the first private key to obtain a procedure parameter; and

obtain the second random polynomial on a third truncated polynomial ring modulo a third system parameter according to the procedure parameter and the second private key.

The decryption unit 12 is further specifically configured to:

calculate, by the second device, on the first truncated polynomial ring modulo the first system parameter according to the procedure parameter and the third private key to obtain the first random polynomial.

The decryption unit 12 is further specifically configured to:

calculate on a second truncated polynomial ring modulo a second system parameter according to the first random polynomial, the second random polynomial, the second ciphertext, and the second public key to obtain the plaintext information.

The first private key is a third random polynomial, the second private key is an inverse element of the third random polynomial on the third truncated polynomial ring modulo the third system parameter, and the third private key is obtained through calculation according to an inverse element of the third system parameter and an inverse element of a fourth random polynomial on the first truncated polynomial ring modulo the first system parameter.

For example, the decryption unit 12 calculates on the first truncated polynomial ring modulo the first system parameter according to the first ciphertext and the first private key to obtain the procedure parameter, and may be specifically configured to:

calculate on the first truncated polynomial ring modulo the first system parameter according to s=fc₁ to obtain the procedure parameter, where f is the first private key, and c₁ is the first ciphertext.

In addition, the decryption unit 12 obtains the second random polynomial on the third truncated polynomial ring modulo the third system parameter according to the procedure parameter and the second private key, and may be specifically configured to:

calculate on the third truncated polynomial ring modulo the third system parameter according to sₚ=s(mod p) and r₂=sₚfₚ⁻¹ to obtain the second random polynomial, where p is the third system parameter, fₚ⁻¹ is the second private key, s is the procedure parameter, and the third truncated polynomial ring is Zₚ[X]/X^{N}−1.

Correspondingly, the decryption unit 12 calculates on the first truncated polynomial ring modulo the first system parameter according to the procedure parameter and the third private key to obtain the first random polynomial, and may be specifically configured to:

calculate on the first truncated polynomial ring according to sₚ=s(mod p) and r₁=(s−sₚ)G to obtain the first random polynomial, where s is the procedure parameter, q₁ is the first system parameter, p is the third system parameter, G is the third private key, and the first truncated polynomial ring is Z_{q}_{₁}[X]/X^{N}−1.

Then the decryption unit 12 calculates on the second truncated polynomial ring modulo the second system parameter according to the first random polynomial, the second random polynomial, the second ciphertext, and the second public key to obtain the plaintext information, and may be specifically configured to:

calculate on the second truncated polynomial ring according to M=c₂−r₁h₂−r₂ to obtain the plaintext information, where c₂ is the second ciphertext, r₁ is the first random polynomial, r₂ is the second random polynomial, and h₂ is the second public key.

The apparatus in this embodiment may be configured to execute the technical solutions of the method embodiments shown in FIG. 1 to FIG. 6. The implementation principle and technical effect of this embodiment are similar to those of the method embodiments shown in FIG. 1 to FIG. 6, and the details are not described herein again.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A method for public-key encrypted communication, comprising:
encrypting, by a first device, random information according to a first public key, to obtain a first ciphertext;
encrypting, by the first device, plaintext information according to a second public key to obtain a second ciphertext, wherein the plaintext information is unencrypted data to be sent by the first device to a second device, the first public key is represented in a form of a polynomial, the first public key is obtained through calculation on a truncated polynomial ring according to system parameters, the second public key is represented in the form of the polynomial, the second public key is randomly selected on a truncated polynomial ring, and the random information is randomly selected on a truncated polynomial ring; and
sending, by the first device, the first ciphertext and the second ciphertext to the second device.

2. The method according to claim 1, wherein the random information comprises a first random polynomial and a second random polynomial, and the encrypting, by the first device, the random information according to the first public key to obtain the first ciphertext specifically comprises:
calculating, by the first device, on a first truncated polynomial ring modulo a first system parameter according to the first public key, the first random polynomial, and the second random polynomial, to obtain the first ciphertext.

3. The method according to claim 2, wherein the plaintext information is represented as a polynomial on a second truncated polynomial ring modulo a second system parameter, and the encrypting, by the first device, the plaintext information according to the second public key to obtain a second ciphertext specifically comprises:
calculating, by the first device, on the second truncated polynomial ring modulo the second system parameter according to the second public key, the first random polynomial, the second random polynomial, and the plaintext information, to obtain the second ciphertext.

4. The method according to claim 2, wherein the calculating, by the first device, on the first truncated polynomial ring modulo the first system parameter according to the first public key, the first random polynomial, and the second random polynomial, to obtain the first ciphertext specifically comprises:
calculating on the first truncated polynomial ring according to c₁=r₁h₁+r₂ to obtain the first ciphertext, wherein h₁ is the first public key, r₁ is the first random polynomial, r₂ is the second random polynomial, the first truncated polynomial ring is Z_{q}_{₁}[X]/X^{N}−1, and q₁ is the first system parameter.

5. The method according to claim 3, wherein the calculating, by the first device, on the second truncated polynomial ring modulo the second system parameter according to the second public key, the first random polynomial, the second random polynomial, and the plaintext information, to obtain the second ciphertext specifically comprises:
calculating on the second truncated polynomial ring according to c₂=r₁h₂+r₂+M to obtain the second ciphertext, wherein h₂ is the second public key, r₁ is the first random polynomial, r₂ is the second random polynomial, the second truncated polynomial ring is Z_{q}_{₂}[X]/X^{N}−1, and q₂ is the second system parameter.

6. The method according to claim 2, wherein the first public key is obtained through calculation on the first truncated polynomial ring modulo the first system parameter according to the first system parameter, a third random polynomial, and a fourth random polynomial, the third random polynomial has an inverse element on both the first truncated polynomial ring modulo the first system parameter and a third truncated polynomial ring modulo a third system parameter, and the fourth random polynomial has an inverse element on the first truncated polynomial ring modulo the first system parameter.

7. The method according to claim 6, wherein the first public key is obtained through calculation on the first truncated polynomial ring according to h₁=pf_{q}_{₁}⁻¹g, wherein p is the third system parameter, f is the third random polynomial, f_{q}_{₁}⁻¹ is an inverse element of the third random polynomial on the first truncated polynomial ring modulo the first system parameter, g is the fourth random polynomial, q₁ is the first system parameter, and the first truncated polynomial ring is Z_{q}_{₁}[X]/X^{N}−1.

8. The method according to claim 3, wherein the second public key is randomly selected on the second truncated polynomial ring, and the second truncated polynomial ring is Z_{q}_{₂}[X]/X^{N}−1.

9. A method for public-key encrypted communication, comprising:
receiving, by a second device, a first ciphertext and a second ciphertext that are sent by a first device;
calculating, by the second device, according to a first private key, a second private key, and the first ciphertext to obtain a second random polynomial, and obtaining a first random polynomial according to a third private key, wherein the first private key is represented in a form of a polynomial, the first private key is randomly selected on a truncated polynomial ring, the second private key is represented in the form of the polynomial, the second private key is an inverse element of the first private key on the truncated polynomial ring, the third private key is represented in the form of a polynomial, and the third private key is obtained through calculation according to an inverse element of a system parameter and a polynomial ring having an inverse element on a truncated polynomial; and
obtaining, by the second device, plaintext information according to the first random polynomial, the second random polynomial, the second ciphertext, and a second public key, wherein the plaintext information is unencrypted data to be sent by the first device to the second device, the second public key is represented in a form of a polynomial, and the second public key is randomly selected on the truncated polynomial ring.

10. The method according to claim 9, wherein the calculating, by the second device, according to the first private key, the second private key, and the first ciphertext to obtain a second random polynomial comprises:
calculating, by the second device, on a first truncated polynomial ring modulo a first system parameter according to the first ciphertext and the first private key to obtain a procedure parameter; and
obtaining, by the second device, the second random polynomial on a third truncated polynomial ring modulo a third system parameter according to the procedure parameter and the second private key.

11. The method according to claim 10, wherein the obtaining the first random polynomial according to the third private key comprises:
calculating, by the second device, on the first truncated polynomial ring modulo the first system parameter according to the procedure parameter and the third private key to obtain the first random polynomial.

12. The method according to claim 11, wherein the obtaining, by the second device, plaintext information according to the first random polynomial, the second random polynomial, the second ciphertext, and the second public key comprises:
calculating, by the second device, on a second truncated polynomial ring modulo a second system parameter according to the first random polynomial, the second random polynomial, the second ciphertext, and the second public key to obtain the plaintext information.

13. The method according to claim 11, wherein the calculating, by the second device, on the first truncated polynomial ring modulo the first system parameter according to the first ciphertext and the first private key to obtain the procedure parameter comprises:
calculating, by the second device, on the first truncated polynomial ring modulo the first system parameter according to s=fc₁ to obtain the procedure parameter, wherein f is the first private key, and c₁ is the first ciphertext.

14. The method according to claim 13, wherein the obtaining, by the second device, the second random polynomial on the third truncated polynomial ring modulo the third system parameter according to the procedure parameter and the second private key comprises:
calculating, by the second device, on the third truncated polynomial ring modulo the third system parameter according to sₚ=s(mod p) and r₂=sₚfₚ⁻¹ to obtain the second random polynomial, wherein p is the third system parameter, fₚ⁻¹ is the second private key, s is the procedure parameter, and the third truncated polynomial ring is Zₚ[X]/X^{N}−1.

15. The method according to claim 13, wherein the calculating, by the second device, on the first truncated polynomial ring modulo the first system parameter according to the procedure parameter and the third private key to obtain the first random polynomial specifically comprises:
calculating on the first truncated polynomial ring according to sₚ=s(mod p) and r₁=(s−sₚ)G to obtain the first random polynomial, wherein s is the procedure parameter, q₁ is the first system parameter, p is the third system parameter, G is the third private key, and the first truncated polynomial ring is Z_{q}_{₁}[X]/X^{N}−1.

16. The method according to claim 12, wherein the calculating, by the second device, on a second truncated polynomial ring modulo a second system parameter according to the first random polynomial, the second random polynomial, the second ciphertext, and the second public key to obtain the plaintext information comprises:
calculating on the second truncated polynomial ring according to M=c₂−r₁h₂−r₂ to obtain the plaintext information, wherein c₂ is the second ciphertext, r₁ is the first random polynomial, r₂ is the second random polynomial, and h₂ is the second public key.

17. The method according to claim 11, wherein the first private key is a third random polynomial, the second private key is an inverse element of the third random polynomial on the third truncated polynomial ring modulo the third system parameter, and the third private key is obtained through calculation according to an inverse element of the third system parameter and an inverse element of a fourth random polynomial on the first truncated polynomial ring modulo the first system parameter.

18. The method according to claim 17, wherein the third private key is obtained through calculation on the first truncated polynomial ring modulo the first system parameter according to G=p⁻¹g_{q}_{₁}⁻¹, wherein p⁻¹ is an inverse element of the third system parameter modulo the first system parameter, q₁ is the first system parameter, g_{q}_{₁}⁻¹ is an inverse element of the fourth random fourth random polynomial.

19. An apparatus for public-key encrypted communication, comprising:
an encryption unit, configured to encrypt random information according to a first public key to obtain a first ciphertext, and further configured to encrypt plaintext information according to a second public key to obtain a second ciphertext, wherein the plaintext information is unencrypted data to be sent by the first device to a second device, the first public key is represented in a form of a polynomial, the first public key is obtained through calculation on a truncated polynomial ring according to system parameters, the second public key is represented in a form of a polynomial, the second public key is randomly selected on a truncated polynomial ring, and the random information is randomly selected on a truncated polynomial ring; and
a transceiver unit, configured to send the first ciphertext and the second ciphertext to the second device.

20. The apparatus according to claim 19, wherein the random information comprises a first random polynomial and a second random polynomial, and the encryption unit is configured to:
calculate on a first truncated polynomial ring modulo a first system parameter according to the first public key, the first random polynomial, and the second random polynomial to obtain the first ciphertext.

21. The apparatus according to claim 20, wherein the plaintext information is represented as a polynomial on a second truncated polynomial ring modulo a second system parameter, and the encryption unit is further specifically configured to:
calculate on the second truncated polynomial ring modulo the second system parameter according to the second public key, the first random polynomial, the second random polynomial, and the plaintext information to obtain the second ciphertext.

22. The apparatus according to claim 20, wherein the encryption unit is configured to calculate on the first truncated polynomial ring modulo the first system parameter according to the first public key, the first random polynomial, and the second random polynomial to obtain the first ciphertext, and the encryption unit is further configured to:
calculate on the first truncated polynomial ring according to c₁=r₁h₁+r₂ to obtain the first ciphertext, wherein h₁ is the first public key, r₁ is the first random polynomial, r₂ is the second random polynomial, the first truncated polynomial ring is Z_{q}_{₁}[X]/X^{N}−1, and q₁ is the first system parameter.

23. The apparatus according to claim 21, wherein the encryption unit is configured to calculate on the second truncated polynomial ring modulo the second system parameter according to the second public key, the first random polynomial, the second random polynomial, and the plaintext information to obtain the second ciphertext, and the encryption unit is further configured to:
calculate on the second truncated polynomial ring according to c₂=r₁h₂+r₂+M to obtain the second ciphertext, wherein h₂ is the second public key, r₁ is the first random polynomial, r₂ is the second random polynomial, the second truncated polynomial ring is Z_{q}_{₂}[X]/X^{N}−1, and q₂ is the second system parameter.

24. The apparatus according to claim 20, wherein the first public key is obtained through calculation on the first truncated polynomial ring modulo the first system parameter according to the first system parameter, a third random polynomial, and a fourth random polynomial, the third random polynomial has an inverse element on both the first truncated polynomial ring modulo the first system parameter and a third truncated polynomial ring modulo a third system parameter, and the fourth random polynomial has an inverse element on the first truncated polynomial ring modulo the first system parameter.

25. The apparatus according to claim 24, wherein the first public key is obtained through calculation on the first truncated polynomial ring according to h₁=pf_{q}_{₁}⁻¹g, wherein p is the third system parameter, f is the third random polynomial, f_{q}_{₁}⁻¹ is an inverse element of the third random polynomial on the first truncated polynomial ring modulo the first system parameter, g is the fourth random polynomial, q₁ is the first system parameter, and the first truncated polynomial ring is Z_{q}_{₁}[X]/X^{N}−1.

26. The apparatus according to claim 21, wherein the second public key is randomly selected on the second truncated polynomial ring, and the second truncated polynomial ring is Z_{q}_{₂}[X]/X^{N}−1.
